(19) United States
(12) Patent Application Publication
(10) Pub. No.: US 2008/0006750 A1
(43) Pub. Date: Jan. 10, 2008

(54) SAFETY LINE ANCHOR

(75) Inventor: Peter Robert Flux, Inverness-Shire (GB)

Correspondence Address: BROOKS KUSHMAN P.C., 1000 TOWN CENTER, TWENTY-SECOND FLOOR, SOUTHFIELD, MI, 48075, US

(73) Assignee: LATCHWAYS PLC., Wiltshire (GB)

(21) Appl. No.: 11/856,245

(22) Filed: Sep. 17, 2007

Related U.S. Application Data
(63) Continuation of application No. 09/890,771, filed on Mar. 5, 2002, now abandoned.

(30) Foreign Application Priority Data
Feb. 8, 1999 (GB) 9902780.7

(51) Int. Cl. A62B 1/04

(52) U.S. Cl. 248/231.9

(57) ABSTRACT

A bottom anchor assembly (10) for a substantially vertically-oriented elongate safety line (70) comprises safety line gripping means (20), safety line tensioning means (80) and a bracket (50). The gripping means (20) includes a manually adjustable clamp (20) and the tensioning means (80) includes a hollow shaft (40) through which the safety line (70) passes. The hollow shaft (40) is externally screw-threaded and carries the load-setting means (80) on its screw-threaded portion (41). The load-setting means (80) is adapted to bear against the underside of the bracket (50) for adjusting the safety line tension to a predetermined value.

### CROSS-REFERENCE TO RELATED APPLICATIONS

This application is a continuation of application Ser. No. 09/890,771 submitted on Mar. 5, 2002 by Peter Robert Flux with the title SAFETY LINE ANCHOR under 35 U.S.C. 371 from Patent Cooperation Treaty Application PCT/GB00/00371 which was filed on Feb. 8, 2000.

### BACKGROUND OF THE INVENTION

1. Field of the Invention

The present invention relates to height safety equipment and, in particular, to an anchoring arrangement suitable for anchoring the lower end of a temporary installation of a flexible elongate safety line disposed in a substantially vertical orientation on a tall structure.

2. Background Art

Tall structures such as electricity pylons and radio or satellite communication masts are periodically inspected to determine whether any maintenance work is required. These structures are purposely built to be low maintenance and, because many of them stand in remote locations, they may require inspection only once every ten years, perhaps longer.

Also, in the interests of public safety, such structures are constructed to discourage easy ascent by non-authorised personnel. Hence, the lower leg portions of metal towers of this type are usually plain metal to a height of at least three meters from ground level, with no foot- or hand-holds. In fact, if such structures were built with access-ways or the like, the access-ways themselves would require periodic inspection for compliance with safety regulations. The interval between routine safety inspections is shorter than the required interval between routine maintenance inspections, so it would significantly increase the frequency of inspection for any kind of permanent access-way to form part of the tall structure.

Traditionally, personnel who have carried out maintenance inspections on metal towers, pylons, or the like have used rope-access techniques for ascent and making themselves fast at the top. In an effort to minimise some of the hazards associated with such work, the present applicants have devised a fall arrest system that can be installed temporarily on a tall structure for the duration of a routine maintenance inspection, then removed and installed on another tall structure and so on. The advantage of a temporary installation is that it does not require safety inspection in situ. Rather, the system can be removed to a convenient inspection site and inspected whenever necessary.

The above-mentioned temporary fall arrest system uses known components for the most part, but includes a new bottom anchor assembly for securing a substantially vertically-oriented safety line to the lower portion of a tall structure. The anchor assembly is a quick-release device that is significant in being manually operable to working tension. The new bottom anchor also allows a safety line of indeterminate length to be installed, with the excess line being held on a spool beyond the bottom anchor. The bottom anchor is designed to grip the safety line in a non-destructive fashion so that it can be reused repeatedly for a series of inspections on many tall structures. It can also accommodate differences in height between successive tall structures by allowing a different length of safety line to be passed through it before the gripping action is made.

In achieving the aforementioned objects, it should be borne in mind that the critical tension in a substantially vertically-disposed safety line is in its upper portion. The lower portion needs to be secured against the effects of buffeting by wind, but the safety line is inherently under tension below the top anchor by virtue of its own weight.

### SUMMARY OF THE INVENTION

The invention is a fall arrest bottom anchor assembly for use with a substantially vertically-oriented elongate safety line. The bottom anchor assembly includes a safety line gripper, a safety line tensioner, and a bracket that is adapted to be fixedly mounted. The gripper includes a manually adjustable clamp that can be clamped to the safety line at an adjustable position along its length. The tensioner includes a hollow shaft connected to the gripper. The hollow shaft is adapted to receive the safety line with the safety line extending therethrough and extending both upwardly and downwardly therefrom, and the hollow shaft extends vertically through the fixed bracket downwardly and upwardly from the fixed bracket. The hollow shaft has an externally screw-threaded portion. A load setter of the anchor assembly is threadingly adjustable on the screw-threaded portion of the hollow shaft below the fixed bracket to bear against the underside of said fixed bracket for adjusting the safety line tension to a predetermined value.

The manually adjustable clamp as disclosed is secured to the safety line below the fixed bracket below the hollow shaft.

Preferably, the manually adjustable clamp includes of a pair of clamp blocks adapted to be placed in face-to-face opposing relationship around the safety line immediately beneath the hollow shaft. Most preferably, the clamp blocks are provided with mutually-aligned grooves or recesses substantially conforming to the profile of the safety line. The clamp blocks may be loosely clamped to each other using screw-threaded fastening means for initial assembly and may include a further screw-threaded fastener for applying the final clamping torque.

### BRIEF DESCRIPTION OF THE DRAWINGS

The invention will now be described by way of example only with reference to the drawings, in which:

FIG. 1 is a perspective view of an embodiment of the present invention in fully-assembled form.

FIG. 2 is a perspective view of a first manually-adjustable clamping arrangement in accordance with the present invention.

FIG. 3 is an exploded perspective view of the arrangement depicted in FIG. 2.

FIG. 4 is an exploded perspective view of a tensioning device suitable for use in the present invention.

FIG. 5 is a close-up perspective view of a tensioning device in the Process of being installed on a bracket in accordance with a preferred embodiment of the invention.

FIG. 6 is a perspective view of a second manually-adjustable clamping arrangement in accordance with the present invention.

FIG. 7 is an exploded perspective view of the arrangement of FIG. 6.

FIG. 8 is a perspective view of a third manually-adjustable clamping arrangement in accordance with the present invention.

FIG. 9 is an exploded perspective view of the arrangement depicted in FIG. 8.

FIG. 10 is a further perspective view of the arrangement depicted in FIG. 8.

FIG. 11 is a further exploded perspective view of the arrangement depicted in FIG. 8.

FIG. 12 is a perspective view of a fourth manually-adjustable clamping arrangement in accordance with the present invention.

FIG. 13 is a partial exploded perspective view of the arrangement depicted in FIG. 12.

### DETAILED DESCRIPTION OF THE PREFERRED EMBODIMENTS

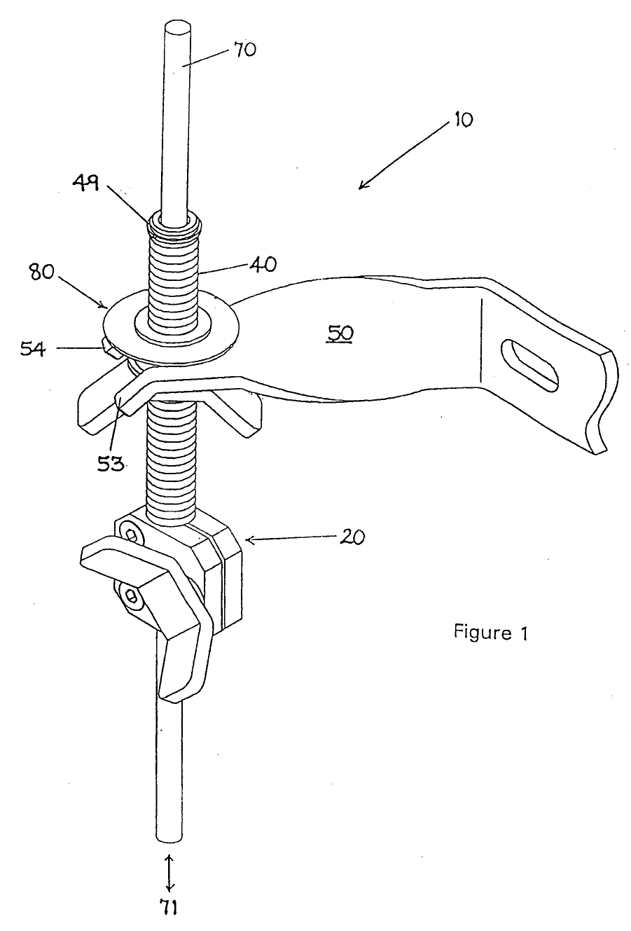

Referring firstly to FIG. 1, there is shown a perspective view of a bottom anchor assembly 10 attached to a safety line 70 in the form of a multi-stranded metal cable. Typically, the cable diameter for a vertical fall arrest system is 8 mm.

The bottom anchor assembly consists of a bottom-mounted clamp 20, an externally screw-threaded hollow shaft 40 projecting upwardly from an upper surface of the clamp 20, a bracket 50 for attaching the anchor assembly to the lower portion of a tall structure such as an electricity pylon (not shown) and a load-setting device 80 a portion of which is adapted to bear against the underside of the jaws of the bracket 50. The hollow shaft 40 may include a circlip 49 at its upper end for ensuring that the load-setting device, once installed on the hollow shaft 40, does not become inadvertently lost.

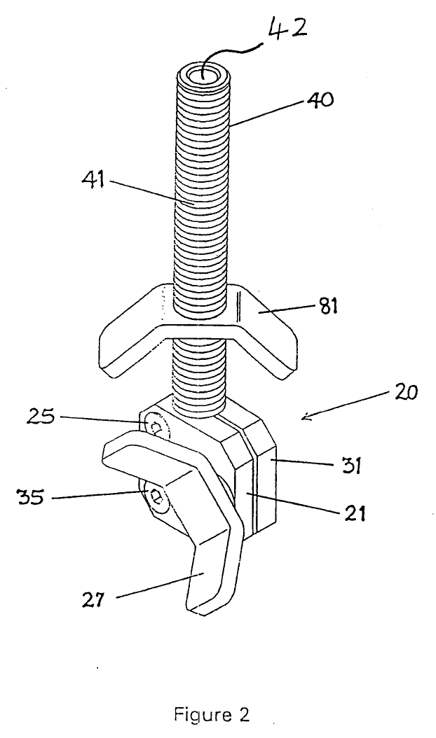

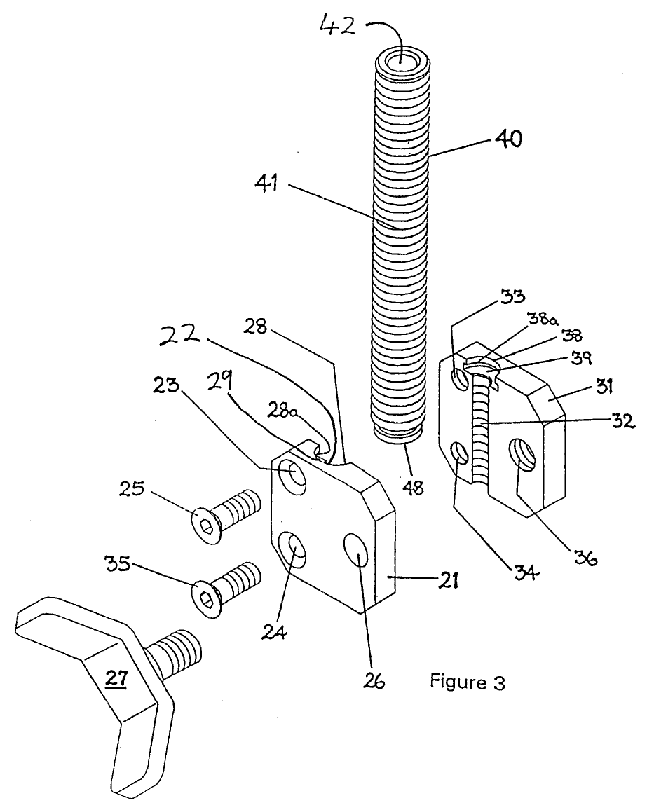

Referring now to FIGS. 2 and 3, the clamp 20 comprises a pair of clamp blocks 21, 31 adapted to be butted together in face-to-face opposing relationship around the safety line 70. The safety line 70 is omitted from these views for clarity. The clamp blocks 21, 31 each have a semi-circular groove 22, 32 formed in their respective opposing faces. The grooves 22, 32 may be provided with surface formation such as serrations, or a surface finish such as a metal spray for roughening, to enhance the gripping action on the safety line 70. As shown, one of the clamp blocks 21 is provided with a pair of countersunk bores 23, 24 whilst the other clamp block 31 is provided with a pair of threaded bores 33, 34 adapted to be in alignment with the countersunk bores 23, 24 when the clamp blocks are in opposing relationship. The bores 23, 24, 33, 34 receive respective threaded bolts 25, 35 which are used to assemble the clamping unit loosely for initial installation. The clamp block 21 further includes a plain through-hole 26, whilst the clamp block 31 further includes a third threaded hole 36 adapted to be in alignment with the through-hole 26 when the clamp blocks are in opposing relationship. The holes 26, 36 receive a wing nut 27 which is manually tightened to achieve the desired clamping force on the safety line 70.

The exploded view of FIG. 3 does not allow this feature to be shown, but wing nut 27 is preferably captive in one of the clamp blocks, most preferably in the clamp block 31 having the threaded hole 36.

Still with reference to FIGS. 2 and 3, the clamp blocks 21, 31 each have a semi-circular recess 28, 38 in their uppermost surfaces, said recesses forming shoulder means 29, 39 at the junction of the recesses 28, 38 with the grooves 22, 32. The shoulder means 29, 39 form a plat form upon which the hollow shaft 40 is positioned during installation of the anchor assembly.

The hollow shaft 40 is preferably held captive in the recesses 28, 38 when the clamp blocks 21, 31 are in opposing relationship by virtue of an undercut formation 28a, 38a provided at the base of recesses 28, 38. The undercut formation 28a, 38a is dimensioned to receive a flange 48 at the base of hollow shaft 40. Preferably, the hollow shaft 40 is still capable of rotation relative to the clamp blocks 21, 31. This enables torsional stresses in the safety line 70 to be relieved whilst maintaining the desired tension.

Once fully installed, the anchor device behaves like a unitary assembly owing to the capture of the hollow shaft 40 in the clamping means 20. This also means that the device can be installed the other way up from the orientation shown in the drawings, since the hollow shaft 40 is held captive relative to the safety line 70 by virtue of its engagement in the clamping means 20.

The hollow shaft 40 has an external screw thread 41, the purpose of which is explained in detail below, and a through-bore 42 dimensioned to receive the safety line 70 as a loose sliding fit. The safety line 70 must not be an interference fit in the through-bore 42, otherwise it becomes difficult to control the tension in the system with precision. Neither is it desirable for the through-bore 42 to be very much wider than the diameter of the safety line 70 since this results in the device being more bulky than necessary and may also increase the likelihood of the safety line chafing at the ends of the hollow shaft 40.

Turning now to FIG. 4, there is shown an embodiment of a load-setting means 80 in exploded perspective view. The load-setting means 80 comprises, in order from the bottom upwards, a first wing nut 81 having a screw threaded through-hole 81a of complementary thread pattern to the external screw thread 41 of the hollow shaft 40, an annular rubber block 82, and a second wing nut 83, also having a screw threaded through-hole 83a of complementary thread pattern to the external screw thread 41 of the hollow shaft 40. In use, the first wing nut 81 acts as a locking nut to secure the second wing nut 83 in position on the hollow shaft 40 when the load-setting means 80 has been adjusted to the desired tension. The rubber block 82 between the first and second wing nuts 81, 83 ensures that the assembly does not become locked up.

Next in order above the second wing nut 83 is a flanged collar 84 having an annular circlip-retaining groove 84a at its upper end. Above the collar 84 is a wave spring 85, then a thrust washer 86 and a spacer 87. In alternative embodiments, the wave spring may be substituted by a crest spring, a disc spring, or even a compression spring. Also, the thrust washer 86 and the spacer 87 may be an integrally-formed single component. Above the spacer 87 is a tenser disc 88, typically in the form of a M24, Form D washer. The spacer 87 has a longitudinal dimension such that the jaws of bracket 50 are receivable between the upper surface of thrust washer 86 and the underside of tenser disc 88. The load-setting means 80 is completed by a retaining circlip 89 at the upper end as viewed in the Figure.

The components denoted by the reference numerals 85 to 89 form a unitary assembly on the shank of the flanged collar 84, the circlip 89 being received in the circlip-retaining groove 84a of the flanged collar 84. The flanged collar 84 has a plain bore that enables it to slide freely over the external screw thread 41 of the hollow shaft 40. The arrangement of the assembled load-setting means 80 is such that the wave spring 85 exerts a compressive force urging the tenser disc 88 into frictional engagement with the upper rim of the spacer 87 and the underside of circlip 89. This prevents rotation of the tenser disc 88 relative to its immediate neighbours, until the desired tension has been imparted to the system in the manner to be described in more detail below.

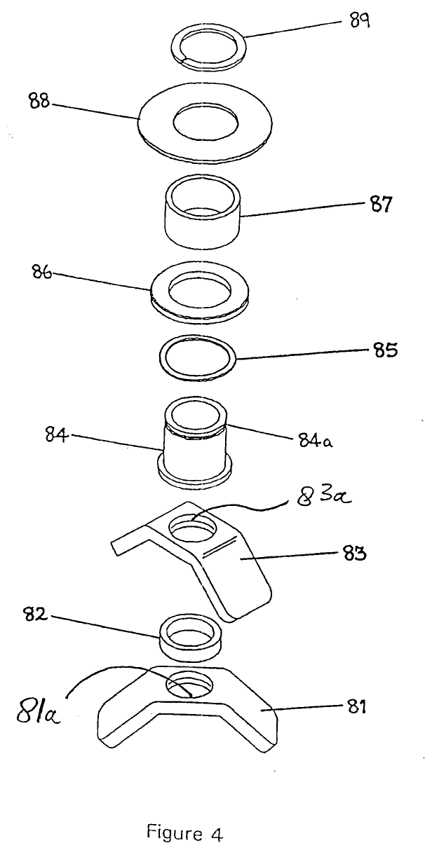

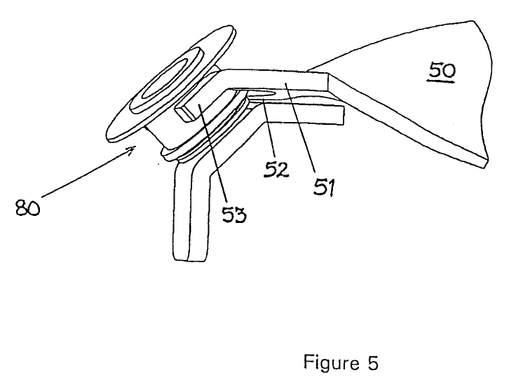

Referring now to FIG. 5, this view shows a load-setting means 80 being slotted into the jaws 51, 52 of bracket 50. Here, the load-setting means 80 is shown in an inverted orientation relative to the exploded view of FIG. 4. However, inversion of orientation does not affect the working principle of the load-setting means 80. As previously described, the ends of the bracket jaws 51, 52 have down-turned portions in the form of lugs 53, 54 (see also FIG. 1) which serve to prevent the accidental removal of the load-setting means from between the jaws 51, 52 by inhibiting lateral movement of the load-setting means 80 once the system is adjusted to its predetermined tension. For the sake of clarity, the hollow shaft 40 and the safety line 70 have been omitted from FIG. 5, but it will be understood from the explanation below that these features are present when the load-setting means 80 is installed in the bracket 50.

Referring once again to FIG. 1, bracket 50 is releasably secured to the lower portion of a leg (not shown) of a tall structure such as a metal tower, a pylon, or the like in a known manner. Hollow shaft 40 carrying the load-setting means 80 is fed onto the safety line 70 from the direction of its free end indicated by the reference numeral 71 and positioned roughly adjacent the jaws 51, 52 of the bracket 50. The manually adjustable clamp 20 is then installed on the safety line 70 just beneath the hollow shaft 40 and is fastened to the safety line 70 by manually tightening the wing nut 27. At this moment during installation of the bottom anchor assembly 10, the safety line 70 is still free and sufficiently flexible that the load-setting device 80 can be tilted for insertion past the lugs 53, 54 of the bracket 50 and thence into the jaws 51, 52 thereof. The jaws 51, 52 of the bracket 50 are positioned between the thrust washer 86 and the tenser disc 88. The wing nut 83 is then rotated (by hand) to urge the flanged collar 84 upwards, forcing thrust washer 86 hard against the underside of the jaws 51, 52 of the bracket 50. The flanged collar 84 is moved upwardly relative to the thrust washer 86 by compressing the wave spring 85 until a point is reached when the tenser disc 88 is no longer held captive between the spacer 87 and the circlip 89, but is rotatable relative thereto. The point at which rotation of the tenser disc 88 is just possible indicates attainment of the desired tension in the system.

The first wing nut 81 can then be rotated (again by hand) against the resilience of rubber block 82 to lock second wing nut 83 and thereby ensure against relaxation of the tension in the safety line 70.

To release the safety line 70 from the bottom anchor assembly 10, the above procedure is reversed.

Because the bottom anchor assembly 10 uses a hollow shaft 40 and a non-terminal clamping block 20, the safety line 70 is permitted to extend beyond the bottom anchor assembly 10. There is no need to cut the safety line 70 to suit the height of the particular tall structure to which it is being fastened. Rather, the excess (that portion which extends in the direction of arrow 71) safety line can be coiled on a spool or drum onto which it can be rewound when the inspection is complete and the safety line installation is dismantled.

Referring to FIGS. 6 and 7, a second alternative clamp 90 which can be used to replace the clamp 20 described above is shown. The clamp 90 operates with an externally screw threaded hollow shaft 91 which functions similar to the hollow shaft 40 described previously to allow the load on the safety line 70 to be set.

The clamp 90 comprises a partially conical collet grip 92, a winged nut 93 and circlip 94. The threaded main body section 93a and wing section 93b of the winged nut 93 can conveniently be manufactured separately and accordingly are shown exploded apart in FIG. 7. However, the main body section 93a and wing section 93b will be permanently joined, for instance by welding, to form the winged nut 93 and are not intended to be separable in use.

The collet grip 92 is retained within the end of the hollow shaft 91 by the winged nut 93, the winged nut 93 having an internal thread arranged to engage the external thread on the hollow shaft 91.

The winged nut 93 has a circlip groove 93c and a groove 91 a is formed as a gap in the external threads on the hollow shaft 91. The circlip 94 is held in the circlip groove 93c and the circlip groove 91 a to retain the collet grip 92 and winged nut 93 on the hollow shaft 91 and prevent their accidental loss. The width of the circlip groove 91 a must be sufficient to allow the circlip 94 to float within the circlip groove 91 a to allow the full range of movement of the winged nut 93.

In operation, the safety line 70, which is omitted from the figures for clarity, passes through the hollow shaft 91 as before and through the collet grip 92 and winged nut 93. Manual tightening of the winged nut 93 drives the collet grip 92 into the end of the hollow shaft 91, urging the collet grip 92 to close and so grip the safety line 70.

Preferably, the collet grip 92 is capable of rotation relative to the hollow shaft 91 and winged nut 93 in order to allow torsional stresses in the safety line 70 to be relieved whilst maintaining the desired tension.

The hollow shaft 91, like the hollow shaft 40, may include a circlip 49 at its upper end to ensure that the load setting device, once installed on the hollow shaft 91, does not become inadvertently lost.

At the opposite end of the hollow shaft 91 to the clamp 90 a short section at the end of the hollow shaft 91 has no external threads and at least one pair of opposed flat faces 91b. The flat faces 91b allow the hollow shaft 91 to be gripped by a spanner or similar tool to hold the hollow shaft 91 against rotation so that the winged nut 93 can be tightened or loosened.

Once fully installed, the anchor device behaves like a unitary assembly owing to the capture of the hollow shaft 91 in the clamping means 90. This means that, in principle, the device can be installed the other way up from the orientations shown in the drawings. However, it will normally be preferred to only install the device in the orientation shown where the tension applied to the safety line 70 tends to pull the collet grip 92 into tighter engagement with the hollow shaft 91. The advantage of this orientation is that if a fall arrest event occurs the additional load on the safety line will tend to pull the collet grip 92 into tighter engagement with the hollow shaft 91. If the orientation were reversed the excess load caused by a full arrest event would have to be carried by the winged nut 93.

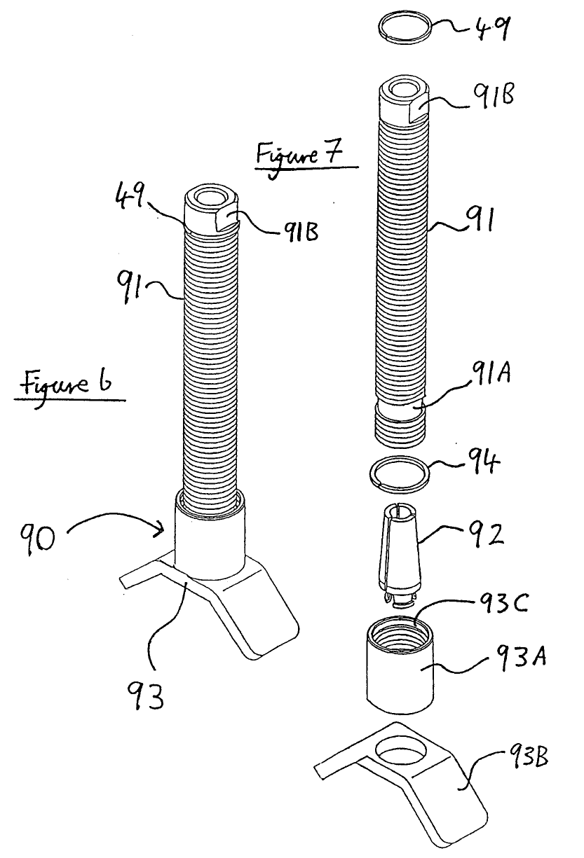

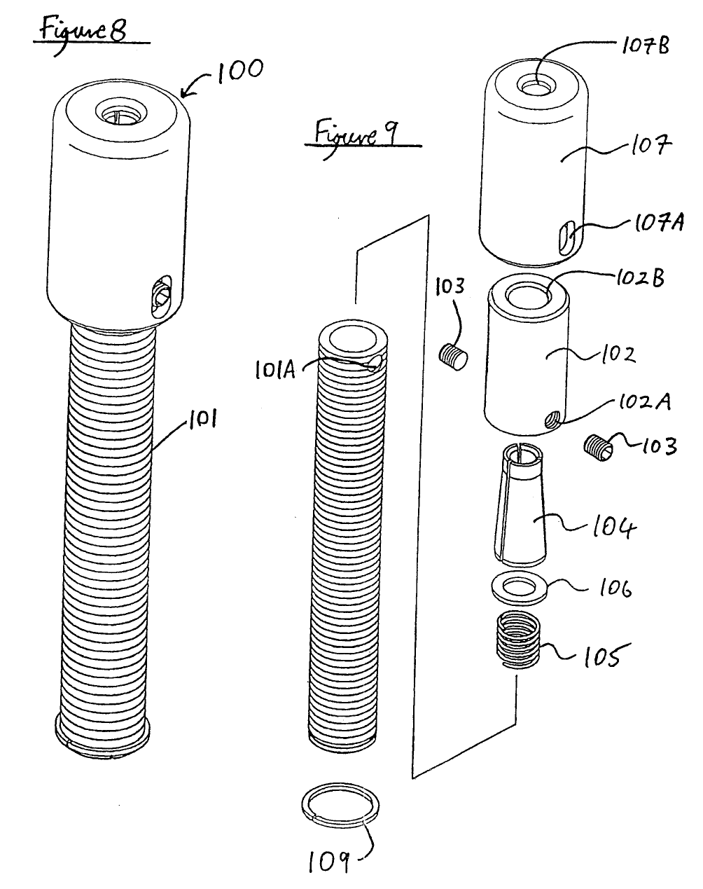

A third alternative clamping arrangement is shown in FIGS. 8 to 11.

In this arrangement an alternative clamp 100 is used, attached to one end of a hollow shaftlol similar to the hollow shaft 40.

The clamp 100 comprises a collet grip 104 located within a clamp body 102. The clamp body 102 has an internal thread (not shown) which engages the external thread on the hollow shaft 101. Further, the clamp body 102 has a pair of internally threaded radial bores 102a. Bolts 103 screw into the bores 102a and into corresponding recesses 101 a on the outer surface of the hollow shaft 101 to retain the clamp body 102 on the end of the hollow shaft 101.

The collet grip 104 is retained within the clamp body 102 with the narrow end of the collet grip 104 passing through an aperture 102b in the clamp body 102. The collet grip 104 is urged though the aperture 102b and held in contact with the clamp body 102 by a spring 105 which is held in compression between the end of the hollow shaft 101 and a washer 106 in contact with the wider end of the collet grip 104.

A hollow cover 107 is arranged to have a sliding fit over the outer surface of the clamp body 102 and has two slot shaped apertures 107a in its side surface. The bolts 103 and cover 107 are arranged so that the head ends of the bolts 103 which are exposed above the surface of the clamp body 102 pass into the apertures 107a to retain the cover 107 over the gripping body 102 while allowing the cover 107 to move axially relative to the clamp body 102 and the hollow shaft 101.

The cover 107 has an end aperture 107b through which the safety line 70 can pass and is arranged so that the collet grip 104 bears against an inner end surface of the cover 107 around the aperture 107b.

In operation, the safety line 70 passes through the clamp 100 and hollow shaft 101 as before. The collet grip 104 is biased by the spring 105 against the clamp body 102 so that the collet grip 104 is biased to grip the safety line 70. In order to release the collet grip 104 from the safety line 70, the cover 107 must be urged towards the hollow shaft 101, that is downwards in the figures, so that the cover 101 urges the collet grip 104 away from the clamp body 102 so that the grip of the collet grip 104 on the safety line 70 is released.

The collet grip 104 can rotate relative to the hollow shaft 101 in order to enable torsional stresses in a safety line 70 to be relieved while maintaining the desired tension. A circlip 109 may be placed on the end of the hollow shaft 101 opposite the clamp 100 to ensure that the load setting device, once installed on the hollow shaft 101, does not become inadvertently lost.

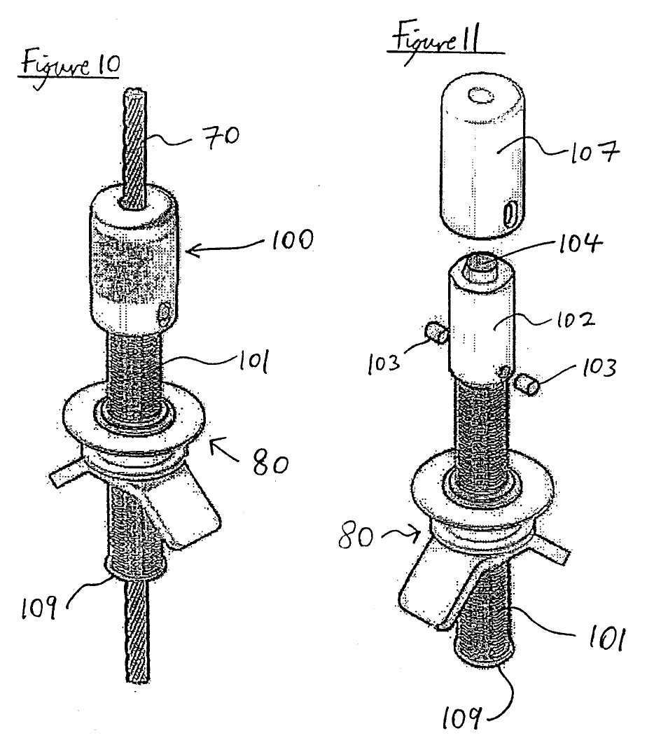

The clamp 100 is further shown in FIG. 10 which shows the clamp assemble together with the load setting device 80 and safety line 70 and in FIG. 11 which shows the assemble clamp 100 with the cover 107 removed to show the end of the collet grip 104 protruding from the collet body 102. For clarity, the safety line 70 is omitted in FIG. 11.

The clamp 100 shown in FIGS. 8 to 12 allows the safety line 70 to be freely pulled through in one direction, downward in the figures, because movement of the cable in this direction will automatically pull the collet grip 104 out of engagement with the clamp body 102 and so release the grip of the collet grip 104 on the safety line 70, while movement of the safety line 70 in the opposition direction, upwards in the figures, will be prevented because forces applied to the safety line 70 in this direction will urge the collet grip 104 against the gripping body 102 and increase the gripping force exerted on the safety line 70. This automatic one way action has the advantage of allowing easier adjustment of the assembly to pull though excess safety line. However, the one way gripping action means that the clamp 100 can only be used on one end of the threaded shaft 101, the top end in the figures.

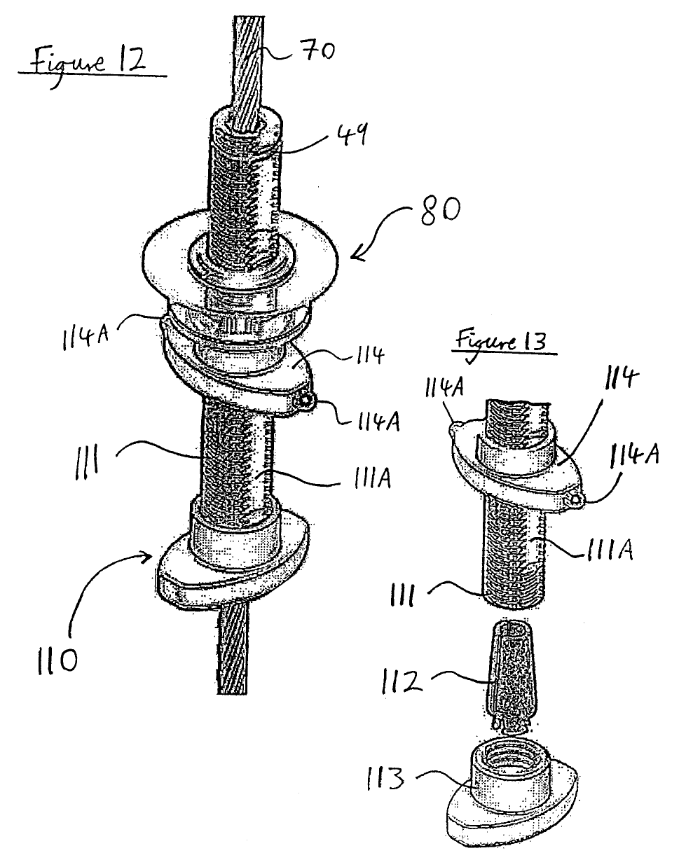

A fourth alternative clamp arrangement 110 is shown in FIGS. 12 and 13.

In this clamp 110 a collet grip 112 is urged into one end of a hollow shaft 111 by a winged nut 113 similarly to the arrangement shown in FIGS. 6 and 7.

In the clamp 110 the hollow shaft 111 has at least one flat 111 a extending along most of its length. The flat 111 a stops short of the end of the hollow shaft 111 where the winged nut 113 is located so that the external threads are continuous in this region.

A second wing nut or hand grip 114 is provided having an engagement mechanism (not shown) arranged to selectively lock the rotational position of the hand grip 114 relative to the hollow shaft 111 and an internal thread able to cooperate with the external thread of the hollow shaft 111. The gripping mechanism is controlled by two push buttons 114a on the hand grip 114.

In order to tighten or loosen the clamp 110 the buttons 114a are pressed to release the hand grip 114 from the hollow shaft 111 and the hand grip 114 is then rotated along the thread of the hollow shaft 111 to a convenient position. The buttons 114a are then released to lock the rotational position of the hand grip 114 relative to the hollow shaft 111. The hand grip 114 can then be used to hold the hollow shaft 111 in position while the winged nut 113 is rotated to engage or release the collet grip 112 from the safety line 70.

The advantage of this arrangement over the arrangement shown in FIGS. 6 and 7 is that no spanner or other separate tool is required to tighten or release the clamp 110.

Although the invention has been particularly described above with reference to specific embodiments, it will be understood that modifications and variations are possible without departing from the scope of the claims which follow.

What is claimed is:

1. A fall arrest bottom anchor assembly for use with a substantially vertically-oriented elongate safety line, said bottom anchor assembly comprising a safety line gripper, a safety line tensioner, a bracket that is adapted to be fixedly mounted, wherein the gripper includes a manually adjustable clamp that can be clamped to the safety line at an adjustable position along its length, the tensioner including a hollow shaft connected to the gripper, the hollow shaft being adapted to receive the safety line with the safety line extending therethrough and extending both upwardly and downwardly therefrom, said hollow shaft extending vertically through the fixed bracket downwardly and upwardly from the fixed bracket and the hollow shaft having an externally screw-threaded portion, and a load setter threadingly adjustable on the screw-threaded portion of the hollow shaft below the fixed bracket to bear against the underside of said fixed bracket for adjusting the safety line tension to a predetermined value.

2. A bottom anchor assembly as in claim 1 wherein the manually adjustable clamp is secured to the safety line below the fixed bracket.

3. A bottom anchor assembly as claimed in claim 1 wherein the manually adjustable clamp includes a pair of clamp blocks adapted to be placed in face-to-face opposing relationship around the safety line immediately beneath the hollow shaft.

4. A bottom anchor assembly as claimed in claim 3 wherein the clamp blocks are provided with mutually-aligned grooves or recesses substantially conforming to the profile of the safety line.

5. A bottom anchor assembly as claimed in claim 4 wherein the clamp blocks are loosely clamped to each other using screw-threaded fasteners for initial assembly and include a further screw-threaded fastener for applying final clamping torque.

6. A bottom anchor assembly as claimed in claim 1 wherein the manually adjustable clamp includes a collet grip through which the safety line passes.

7. A bottom anchor assembly as claimed in claim 6 wherein the collet grip is held between an end of the hollow shaft and a screw threaded fastener engaging the external screw thread on the hollow shaft.

8. A bottom anchor assembly as claimed in claim 7 wherein the collet grip can be opened or closed onto the safety line by rotating the screw threaded fastener relative to the hollow shaft.

9. A bottom anchor assembly according to claim 7 wherein the collet grip is biased closed onto the safety line by a resilient element.

10. A bottom anchor assembly as claimed in claim 8 wherein a sliding release member is provided in contact with the collet grip so that the collet grip can be opened against the bias of the resilient element.

11. A bottom anchor assembly as claimed in claim 1 wherein the bracket includes open jaw members adapted to receive the hollow shaft.

12. A bottom anchor assembly as claimed in claim 11 wherein the open jaw members have ends provided with down-turned portions which serve to prevent accidental removal of the load setter threaded on the hollow shaft from between the jaw members when the system is adjusted to its predetermined tension.

13. A bottom anchor assembly as claimed in claim 1 further comprising an indicator for providing a visible indication of when said predetermined tension has been achieved.

14. A fall arrest bottom anchor assembly for use with a substantially vertically-oriented elongate safety line, said bottom anchor assembly comprising a safety line gripper, a safety line tensioner, a bracket that is adapted to be fixedly mounted, wherein the gripper includes a manually adjustable clamp that can be clamped to the safety line at an adjustable position along its length at a location below the fixed bracket, the manually adjustable clamp including a pair of clamp blocks adapted to be placed in face-to-face opposing relationship around the safety line, the tensioner including a hollow shaft connected to the gripper below the fixed bracket, the hollow shaft being adapted to receive the safety line with the safety line extending therethrough and extending both upwardly and downwardly therefrom, said hollow shaft extending vertically through the fixed bracket downwardly and upwardly from the fixed bracket and the hollow shaft having an externally screw-threaded portion, and a load setter threadingly adjustable on the screw-threaded portion of the hollow shaft below the fixed bracket to bear against the underside of said fixed bracket for adjusting the safety line tension to a predetermined value.

15. A fall arrest bottom anchor assembly for use with a substantially vertically-oriented elongate safety line, said bottom anchor assembly comprising a safety line gripper, a safety line tensioner, a bracket that is adapted to be fixedly mounted, wherein the gripper includes a manually adjustable clamp that can be clamped to the safety line at an adjustable position along its length at a location below the fixed bracket, the manually adjustable clamp including a pair of clamp blocks adapted to be placed in face-to-face opposing relationship around the safety line, the clamp blocks being provided with mutually-aligned grooves or recesses substantially conforming to the profile of the safety line and being loosely clamped to each other using screw-threaded fasteners for initial assembly and further using a screw-threaded fastener for applying final clamping torque, the tensioner including a hollow shaft connected to the gripper below the fixed bracket, the hollow shaft being adapted to receive the safety line with the safety line extending therethrough and extending both upwardly and downwardly therefrom, said hollow shaft extending vertically through the fixed bracket downwardly and upwardly from the fixed bracket and the hollow shaft having an externally screw-threaded portion, and a load setter threadingly adjustable on the screw-threaded portion of the hollow shaft below the fixed bracket to bear against the underside of said fixed bracket for adjusting the safety line tension to a predetermined value.
